(19) United States
(12) Patent Application Publication
(10) Pub. No.: US 2007/0119872 A1
(43) Pub. Date: May 31, 2007

(54) Fluid product dispensing head and production method thereof

(76) Inventors: Alexandra Parmentier, La Marengere (FR); Sophie Feschet-Magdelaine, Evreux (FR)

Correspondence Address: SUGHRUE MION, PLLC, 2100 PENNSYLVANIA AVENUE, N.W., SUITE 800, WASHINGTON, DC, 20037, US

(21) Appl. No.: 10/575,095

(22) PCT Filed: Oct. 5, 2004
(86) PCT No.: PCT/FR04/50485

§ 371 Date: Apr. 10, 2006

(30) Foreign Application Priority Data
Oct. 9, 2003 (FR) 0311823

(51) Int. Cl. B65D 88/54; G01F 11/00

(52) U.S. Cl. 222/332; 222/334; 222/336

(57) ABSTRACT

A fluid dispenser head for associating with a fluid dispenser member, said head comprising a body (1) defining a fluid outlet channel (131), a nozzle (2; 2′) defining a dispenser orifice (21), and a cover (3) that is assembled on the body (1) in such a manner as to mask it at least in part, the head being characterized in that the cover (3) is overmolded on the body (1).

The present invention relates to a fluid dispenser head for associating with, or assembling on, a fluid dispenser member. The invention also relates to a method of manufacturing such a dispenser head. In the context of the present invention, the dispenser head comprises a body defining a fluid outlet channel, a nozzle defining a dispenser orifice, and a cover that is assembled on the body in such a manner as to mask it at least in part. Such a dispenser head can be used in the fields of perfumery, cosmetics, or even pharmacy.

Document FR 2 774 367 describes such a dispenser head comprising a body, a nozzle, and a cover. The body is secured inside the cover. The body is held inside the cover by friction forces between the outside wall of the body and the inside wall of the cover. The cover masks the top wall and the peripheral wall of the body. The nozzle is initially assembled on the body before the body is engaged in the cover, or in a variant, the nozzle is inserted into the body once the body is engaged in the cover. Either way, the cover comprises a drum defining a window in which the dispenser orifice formed by the nozzle is positioned.

With the dispenser head of the above-mentioned prior art, the dispenser head is assembled in two distinct assembly operations, namely assembling the nozzle on the body, and assembling the body in the cover. In addition, assembling the body in the cover requires tolerances to be very small so as to ensure that the body is held securely in the cover. However, it ought to be possible to force-fit the body in the cover using reasonable force. This is why both the cover and the body must be made with great precision, and that increases the cost of manufacture. The same applies for the nozzle and the body.

In order to solve the above-mentioned prior-art problems, the cover of the fluid dispenser head of the invention is overmolded on the body. The term “overmolding” means that the body itself forms a portion of the mold used to make the cover. Thus, a portion of the outside surface of the plastics material that is injected into the mold to make the cover comes directly into intimate contact with the body. This contact forms a bond that results in the cover being securely fastened on the body. This overmolding technique ensures that the cover follows all the contours and roughnesses of the body intimately. The body advantageously includes a top surface and a peripheral surface, with the cover being overmolded on the top surface, and also advantageously on the peripheral surface. In some circumstances, it may also be advantageous for the cover to be overmolded on the nozzle after said nozzle has been assembled on the body. Given that the cover is never in contact with the fluid to be dispensed, it can be made of a plastics material that is incompatible with the fluid.

According to another advantageous characteristic of the invention, the cover comprises a drum that is provided with a window through which the nozzle passes for assembly on the body by engaging therewith through the window.

The dispenser orifice is advantageously positioned in the window.

In a variant, the dispenser orifice is positioned set back from the window, substantially in register with an outside surface of the body.

The window preferably presents a frustoconical shape that flares outwards. The frustoconical surface serves as a diffuser cone that makes it possible to channel the sprayed jet of fluid through the dispenser orifice.

In another aspect of the invention, the body includes a peripheral skirt that outwardly forms the peripheral surface, said skirt being provided with an opening that leads to a reception housing for the nozzle, said housing advantageously forming a core around which the nozzle is force-fitted.

According to another characteristic, an insert is disposed between the body and the cover, said cover being made of a translucent or transparent material so that the insert is visible through the cover.

It should be noted that the insert may be interposed between the body and the cover without the cover being overmolded on the body. The characteristic associated with the insert may therefore be independently protected.

According to another characteristic, the nozzle projects outwards from the peripheral surface.

By means of this overmolding technique, it is possible to make the cover after the nozzle has been assembled on the body. This is not possible with the dispenser head in document FR 2 774 367.

The dispenser head of the invention may in particular serve as a pushbutton. In this event, the cover may define a bearing surface for applying pressure so as to actuate the dispenser member.

The invention also defines a method of manufacturing a fluid dispenser head for associating with a fluid dispenser member, said head comprising a body defining a fluid outlet channel, a nozzle defining a dispenser orifice, and a cover that is assembled on the body in such a manner as to mask it at least in part, said method successively comprising a first step of overmolding the cover on the body, and a second step of assembling the nozzle on the body.

In a variant, the invention may also provide a method of manufacturing a fluid dispenser head for associating with a fluid dispenser member, said head comprising a body defining a fluid outlet channel, a nozzle defining a dispenser orifice, and a cover that is assembled on the body in such a manner as to mask it at least in part, the method successively comprising a first step of assembling the nozzle on the body, and a second step of overmolding the cover on the body, and possibly on the nozzle.

An insert is advantageously disposed between the body and the cover, said cover being made of a transparent or translucent material. This is valid for both variants of the method of manufacture.

The invention is described more fully below with reference to the accompanying drawings which show several embodiments of the invention by way of non-limiting example.

In the figures:

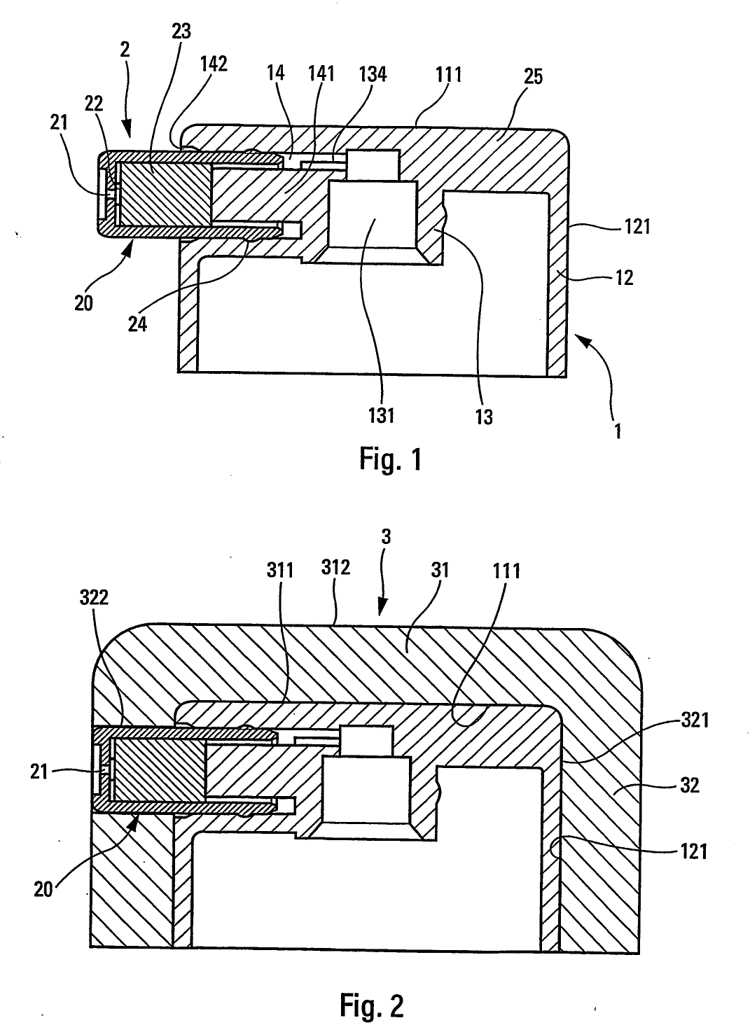

FIG. 1 is a vertical section view through a body fitted with a nozzle constituting a first embodiment;

FIG. 2 is a view similar to the view in FIG. 1 with a cover overmolded on the FIG. 1 body;

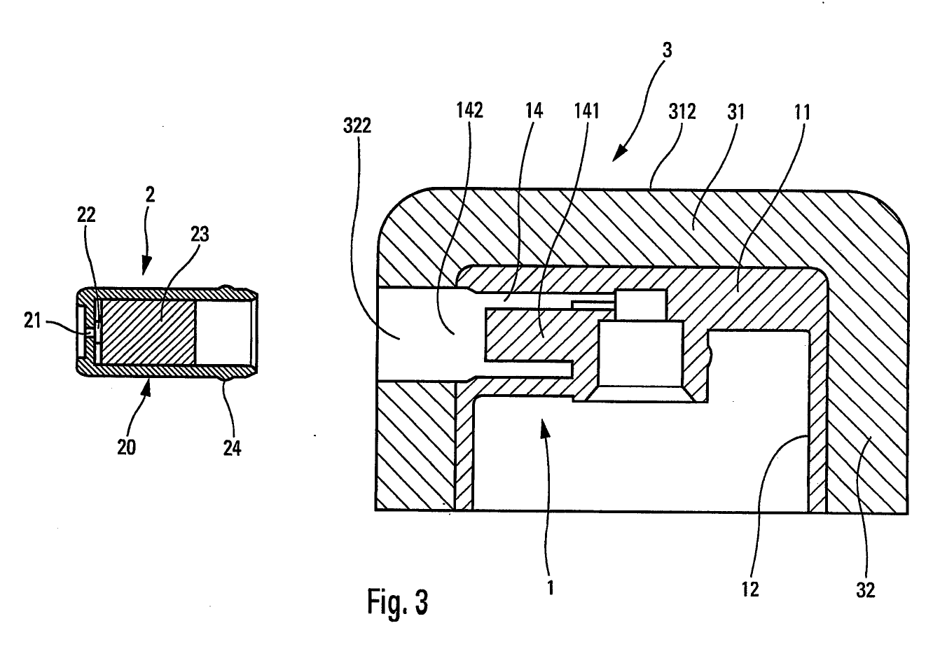

FIG. 3 is a vertical section view through a dispenser head constituting a second embodiment of the invention;

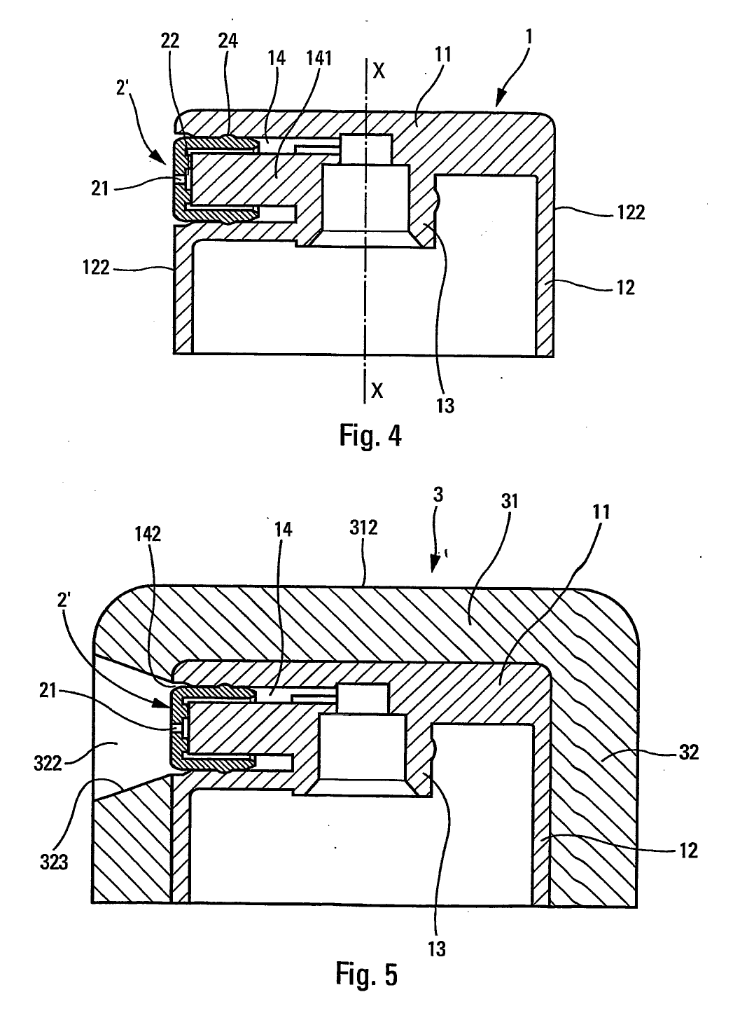

FIG. 4 is a vertical section view through a body and a nozzle constituting a third embodiment;

FIG. 5 is a view similar to the view in FIG. 4 with a cover overmolded on the FIG. 4 body;

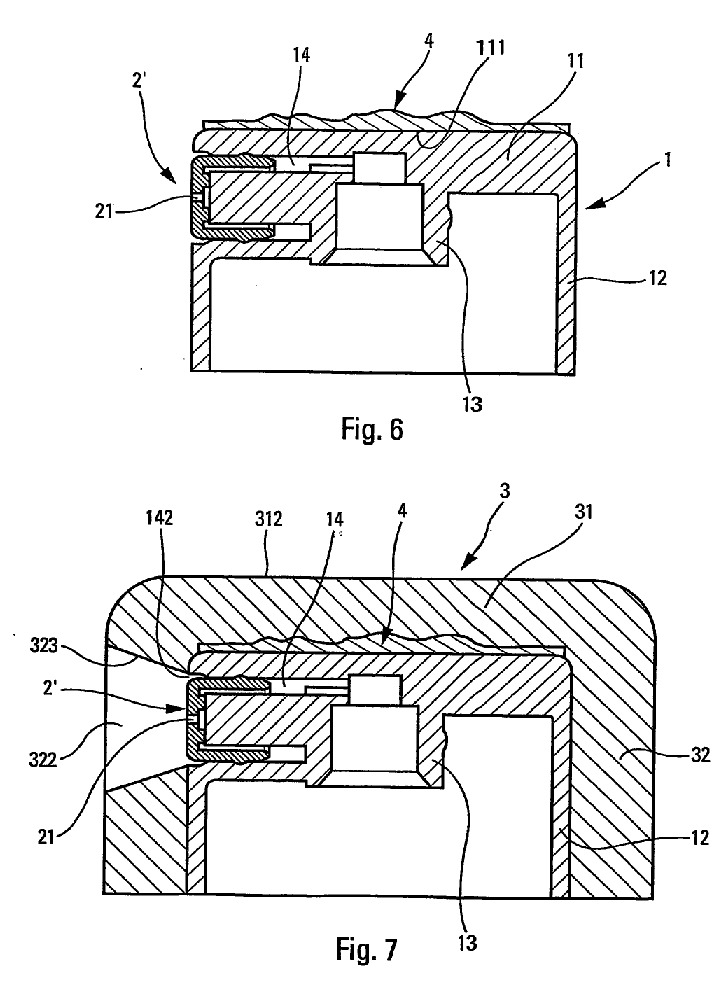

FIG. 6 is a vertical section view through a body and a nozzle constituting a fourth embodiment of the invention; and

FIG. 7 is a view similar to the view in FIG. 6 with a cover overmolded on the FIG. 6 body.

In all of the embodiments shown in the figures, the dispenser head comprises three component elements, namely a body 1, a nozzle 2 or 2′, and a cover 3. However, the body and the nozzle could be made as a single part or in some equivalent manner.

The body 1 is identical in all of the embodiments in the figures. However, other forms can be envisaged for the body 1. In the figures, the body is designed to form a dispenser head of the pushbutton type that is pressed by means of a finger so as to actuate the dispenser member that can be a pump or a valve. However, it is possible to envisage that the body is designed to be associated with a dispenser member (a pump or a valve) in such a manner as to be completely disassociated with the actuator pushbutton. The body 1 would then be for assembly in a manner that is stationary relative to the reservoir, and to the body of the pump or of the valve. In the figures, the pushbutton body 1 can thus be of the standard type, being made of an injection-molded plastics material that is compatible with the fluid to be dispensed. This is necessary because the fluid comes into contact with the material from which the body 1 is made. The body includes a top plate 11 that defines an outer top surface 111. The body also includes a peripheral skirt 12 that defines an outer peripheral surface 121. The outer periphery of the top surface 111 is connected to the substantially or completely cylindrical peripheral surface 121, advantageously via a rounded edge. The plate 11 and the skirt 12 thereby define an upsidedown-cup shape. On its inside and below the plate 111, the body forms a connection sleeve 13 and a reception housing 14. The sleeve 13 defines an internal outlet duct 131 through which the fluid driven by the pump or the valve flows into the housing 14 via a small connection channel 134. The housing 14, more visible in FIG. 3, defines an opening 142 in the peripheral skirt 12. The housing 14 contains a core 141 that is formed integrally with the body 1. The core outwardly defines an annular housing for receiving the nozzle 2 or 21, as described below. This is a fairly conventional design for a standard pushbutton body.

In the embodiments, the nozzle 2 or 2′ comprises a base bushing 20 that is of substantially cylindrical shape, and that is closed at one of its ends by a dispenser wall. The dispenser wall is pierced by a dispenser orifice 21 that can optionally be of the spray type. A portion of the bushing 20 defines a fastener bead 24 for becoming engaged in the annular housing formed around the core 141. As shown in FIGS. 1, 2, and 3, the nozzle can optionally include a filler plug 23. The plug 23 can co-operate with the dispenser wall in such a manner as to form a swirl system that is conventionally constituted by radial swirl channels opening out into a central swirl chamber that is centered on the dispenser orifice 21. In the absence of a filler plug 23, it is the front surface of the core 141 that co-operates with the dispenser wall in order to form the swirl system 22. The particular design of the nozzle 2 or 2′ is not critical to the present invention. It suffices that the nozzle co-operates with the body in order to fulfill its fluid-spraying function. In the embodiment of the nozzle 2 shown in FIGS. 1, 2, and 3, the nozzle projects outwards from the peripheral surface 121 of the body. It is also possible to say that the dispenser orifice 21 projects radially outwards from the peripheral surface 121. In contrast, in the embodiment of the nozzle 2′ shown in FIGS. 4 to 7, the dispenser orifice 21 is substantially in alignment with the peripheral surface 121. It is also possible to say that the nozzle is inscribed within the housing formed by the body. It is also possible to envisage embodiments in which the dispenser orifice is set back inside the housing formed by the body, such that the orifice is inwardly offset relative to the peripheral surface 121. It should also be noted that the nozzle 2 or 2′ is assembled in the housing 14 by being engaged laterally or radially relative to the axis X shown in FIG. 4.

The cover 3 is assembled on the body 1, coming into contact with all or part of the top surface 111 and of the peripheral surface 121. However, in some embodiments, the cover can come into contact with all or part of the top surface 111, while leaving the peripheral surface 121 visible or unmasked. The cover 3 thus masks a major portion of the outside surface of the body 1, while nevertheless leaving its bottom face open and free so as to make it possible to assemble the dispenser head on a dispenser member such as a pump or a valve. The connection sleeve 13 must remain accessible. The cover 3 comprises both a bearing wall 31 forming an outer bearing surface 312, and also a substantially cylindrical peripheral drum 32 that surrounds the skirt 12 of the body 1. The bearing wall 31 includes. an inside surface 311 that comes into intimate contact with the top surface 111 of the plate 11. In addition, the drum 32 forms an inside surface 321 that advantageously comes into intimate contact with the outer peripheral surface 121 of the skirt 12. A window 322 also passes through the drum 32, putting the outside of the drum into communication with the inside of the drum. Depending on the embodiment, the window 322 is for passing or receiving the nozzle 2 or 2′, as described below. The cover 3 can also come into intimate contact with the nozzle 2 at the window 322, as can be seen in FIG. 2. In another embodiment shown in FIGS. 5 and 7, the window 322 can be formed with a frustoconical shape 323 that flares outwards. Naturally, the window 322 should be positioned in alignment with the housing 14, of the body 1, for receiving the nozzle 2 or 2′. The cover 3 can be made of a plastics material that is attractive and that need not be compatible with the fluid to be dispensed. It could also be made of a transparent material or of a material that is silky or rubbery to the touch.

In the invention, the cover 3 is overmolded on the body 1, and also advantageously on the nozzle 2. This signifies that the cover 3 is molded directly onto the body and/or the nozzle 2. This technique makes it possible to obtain intimate contact between the surfaces of the cover and of the body and/or the nozzle.

In the first embodiment in FIGS. 1 and 2, the nozzle 2 is initially engaged radially in its housing 14 formed in the body 1. In the assembled state, the dispenser orifice 21 of the nozzle projects outwards from the skirt 12. Then, the cover 3 is overmolded on the body 1 and on the nozzle 2. Overmolding the cover makes it possible to hold the nozzle 2 permanently on the body 1. A single-unit composite head that cannot be disassembled is thus obtained. It is the cover that holds the entire head together. It should be noted that the dispenser orifice 21 is situated in the window 322 that intimately surrounds the nozzle 2. More precisely, the nozzle 21 is situated in the proximity of the outside surface of the drum 32 of the cover 3.

In the second embodiment in FIG. 3, the cover 3 is firstly overmolded on the body 1. A pin centered on the housing 14 makes it possible to form the window 322 in the cover 3. A subsequent assembly operation consists in passing the nozzle 2 through the window 322 until it becomes engaged in its final assembly position in the housing 14 in the body 1. In its final position, the dispenser head is in the form shown in FIG. 2. However, there is no intimate bonding contact between the cover 3 and the nozzle 2.

In the third embodiment in FIGS. 4 and 5, the nozzle 2′ is initially assembled on the body 1. However, the dispenser orifice 21 does not project out from the body, but remains in alignment with the skirt 12. A subsequent molding operation consists in overmolding the cover 3 on the body 1 with the nozzle 2′ already assembled therein. A pin centered on the nozzle 2′ serves to form a frustoconical window 322 having a frustoconical wall 323 that acts as a diffuser cone for the sprayed jet of fluid.

In the fourth embodiment in FIGS. 6 and 7, the body 1 and the nozzle 2′ can be identical to the body and nozzle in FIG. 4, i.e. with the nozzle 2′ being initially assembled in the body 1. However, in this embodiment, an insert is disposed on the top surface 111 of the body 1. The insert 4 can be merely deposited on, or it can be secured to, the body 1. It is even possible to envisage overmolding the body 1 on the insert 4. The insert 4 can fulfill an appearance or decorative function. Although the insert 4 is shown on the top surface 111, it is also possible to envisage it extending over the peripheral surface 121, or over both the top and the peripheral surfaces. A subsequent molding operation consists in overmolding the cover 3 on the body 1 and on the insert 4. The insert 4 is thus interposed between the body 1 and the cover 3. In this event, the cover 3 is preferably made of a transparent or translucent material so that the insert is visible through the cover 3. Otherwise, the cover 3 can be identical to the cover in FIG. 5, i.e. with a frustoconical window 322.

It should be noted that an attractive or decorative insert can advantageously be associated with a cover that is fitted or fixed on the body in any manner, without the cover 3 necessarily being overmolded on the body 1. In particular, it is possible to envisage that the cover 3 is merely force-fitted on the body 1, as in prior-art document FR 2 774 367.

The term “overmolding” is equivalent to the terms “co-molding” or “dual-injection”. It generally signifies that one element, in this event the cover, is molded onto another element, namely the body and/or the nozzle.

By means of this overmolding technique, any out-of-tolerance defects on the body 1 and on the cover 3 are of no consequence. Furthermore, an assembly operation is eliminated, and the bonding of the nozzle 2 on the body 1 is also improved.

1. A fluid dispenser head for associating with a fluid dispenser member, said head comprising a body (1) defining a fluid outlet channel (131), a nozzle (2; 2′) defining a dispenser orifice (21), and a cover (3) that is assembled on the body (1) in such a manner as to mask it at least in part,
the head being characterized in that the cover (3) is overmolded on the body (1).

2. A dispenser head according to claim 1, in which the body (1) includes a top surface (111) and a peripheral surface (121), with the cover (3) being overmolded on the top surface (111), and also advantageously on the peripheral surface (121).

3. A dispenser head according to claim 1 or claim 2, in which the cover (3) is overmolded on the nozzle (2) after said nozzle has been assembled on the body (1).

4. A dispenser head according to claim 1, in which the cover (3) comprises a drum (32) that is provided with a window (322) through which the nozzle (2; 2′) passes for assembly on the body (1) by engaging therewith through the window (322).

5. A dispenser head according to claim 4, in which the dispenser orifice (21) is positioned in the window (322).

6. A dispenser head according to claim 4, in which the dispenser orifice (21) is positioned set back from the window (322), substantially in register with an outside surface (121) of the body (1).

7. A dispenser head according to claim 6, in which the window (322) presents a frustoconical shape (323) that flares outwards.

8. A dispenser head according to claim 2, in which the body (1) includes a peripheral skirt (12) that outwardly forms the peripheral surface (121), said skirt being provided with an opening (142) that leads to a reception housing (14) for the nozzle, said housing (14) advantageously forming a core around which the nozzle (2; 2′) is force-fitted.

9. A dispenser head according to any preceding claim 1, in which an insert (4) is disposed between the body (1) and the cover (3), said cover being made of a translucent or transparent material so that the insert is visible through the cover.

10. A dispenser head according to any preceding claim 1, in which the nozzle (2) projects outwards from the peripheral surface (121).

11. A dispenser head according to any preceding claim 1, in which the cover (3) defines a bearing surface (312) for applying pressure so as to actuate the dispenser member.

12. A method of manufacturing a fluid dispenser head for associating with a fluid dispenser member, said head comprising a body (1) defining a fluid outlet channel (131), a nozzle (2; 2′) defining a dispenser orifice (21), and a cover (3) that is assembled on the body (1) in such a manner as to mask it at least in part, said method successively comprising a first step of overmolding the cover on the body, and a second step of assembling the nozzle on the body.

13. A method of manufacturing a fluid dispenser head for associating with a fluid dispenser member, said head comprising a body (1) defining a fluid outlet channel (131), a nozzle (2; 2′) defining a dispenser orifice (21), and a cover (3) that is assembled on the body (1) in such a manner as to mask it at least in part, the method successively comprising a first step of assembling the nozzle on the body, and a second step of overmolding the cover on the body, and possibly on the nozzle.

14. A method of manufacture according to claim 12 or claim 13, in which an insert (4) is disposed between the body (1) and the cover (3), said cover being made of a transparent or translucent material.
